(19) United States
(12) Patent Application Publication
(10) Pub. No.: US 2015/0209808 A1
(43) Pub. Date: Jul. 30, 2015

(54) Package for Light Activated Treatment Composition

(71) Applicant: The Procter & Gamble Company, Cincinnati, OH (US)

(72) Inventors: Randall Alan Watson, Cincinnati, OH (US); Alan David Willey, Cincinnati, OH (US); Philip Andrew Sawin, Blue Ash, OH (US); Robb Richard Gardner, Cincinnati, OH (US)

(21) Appl. No.: 14/594,191

(22) Filed: Jan. 12, 2015

Related U.S. Application Data
(60) Provisional application No. 61/931,025, filed on Jan. 24, 2014.

(51) Int. Cl. B05B 11/00; B08B 7/00

(52) U.S. Cl. CPC B05B 11/0005; B05B 11/3009; B08B 7/0035

(57) ABSTRACT

A package for a treatment composition having a container; a dispensing assembly in fluid communication with the container; a treatment composition having a photoactivator, the treatment composition releasably contained in the container; and a light operatively connected to the container or the dispensing assembly. A method for treating a surface having the steps of; providing a package containing in a container a treatment composition having a photoactivator; dispensing the treatment composition onto a surface to be treated; irradiating the treatment composition with a light operatively connected to the package at a juncture in time selected from the group consisting of after the treatment composition has exited the container but before the treatment composition has exited the package, after the treatment composition has exited the package but before the treatment composition has been deposited on the surface, and after the treatment composition has been deposited on the surface.

### FIELD OF THE INVENTION

Package for light activated treatment composition.

### BACKGROUND OF THE INVENTION

Consumers' households have many surfaces that can become soiled. For instance, it is not uncommon for kitchen countertops to be soiled with liquid and solid food remnants or residue resulting from preparing food. Such remnants and residue can provide the opportunity for bacteria, mold, and fungi to establish a population. Populations of such fauna can be unsightly, cause undesirable odors, and pose a risk of illness to people who come into contact with them either directly or indirectly.

There are a variety of household products aimed at cleaning contaminated surfaces. For instance, wipes impregnated with a cleaning composition can be used to wipe contaminated surfaces. There are also compositions designed to be sprayed on surfaces and wiped with a paper towel, wipe, or rag. There are also liquid compositions designed to be poured onto a surface that needs to be cleaned and thereafter wiped. There are also liquid compositions that are designed to be poured onto a paper towel, wipe, or rag prior to using such cleaning implement to clean a surface.

Typically, cleaning compounds contain one or more components including surfactants, bleaches, perfumes, disinfectants, biocides, and the like. Although typical cleaning compositions do provide some cleaning benefit, many may not clean surfaces to the desired degree. For instance, low cost cleaners that contain chlorine bleach are limited in their ability to disinfect and sanitize. For example, such systems are often only able to kill living bacteria and not the endospore, a dormant form of the bacteria for which there are few barriers to becoming reactivated. More aggressive biocides can be used by consumers but more aggressive biocides are generally associated with increased safety concerns.

One cleaning approach that has shown potential in the fields of dish and textile cleaning is the use of photactivated chemistry. Photoactivated chemistry, in its most basic form, is using light to activate a treatment composition. Depending on the nature of the photactivated chemistry, certain spectra, for example ultraviolet and visible, will activate the chemistry. For instance, micronized titanium dioxide in water can be activated by light to become a bleaching system. Photoactivators such as phthalocyanines and naphthalocyanines, including sulphonated zinc phthalocyanine, can be effective as a photo bleaching agent and antimicrobial agent.

In consideration of the efficacy of photoactivated chemistry for cleaning dishes and textiles, there remains the need for devices that will allow consumers to take advantage of photoactivated chemistry when they clean such articles or similar surfaces.

### SUMMARY OF THE INVENTION

A package for a treatment composition comprising: a container; a dispensing assembly in fluid communication with the container; a treatment composition comprising a photoactivator, the treatment composition releasably contained in the container; and a light operatively connected to the container or the dispensing assembly.

A method for treating a surface comprising the steps of; providing a package containing in a container a treatment composition comprising a photoactivator; dispensing the treatment composition onto a surface to be cleaned; irradiating the treatment composition with a light operatively connected to the package at a juncture in time selected from the group consisting of after the treatment composition has exited the container but before the treatment composition has exited the package, after the treatment composition has exited the package but before the treatment composition has been deposited on the surface, and after the treatment composition has been deposited on the surface.

### BRIEF DESCRIPTION OF THE DRAWINGS

FIG. 1 is a side cross sectional view of a package.

FIG. 2 is a schematic of a package having a light disposed on the bottom thereof.

FIG. 3 is a schematic of a package in which the dispensing assembly is connected to the container by a tube.

### DETAILED DESCRIPTION OF THE INVENTION

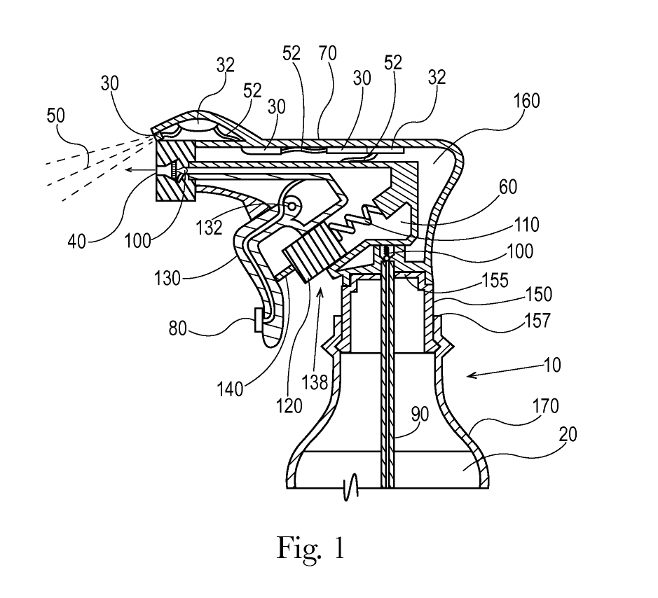

A package 10 for a treatment composition 20 is shown in FIG. 1. FIG. 1 is a side cross sectional view of a package 10. In FIG. 1, the package 10 comprises a container 170 and a dispensing assembly 160 in fluid communication with the container 170. The package 10 can be, by way of non-limiting example, a spray bottle having a trigger activated dispensing assembly 160. The treatment composition 20 can comprise a photoactivator.

The dispensing assembly 160 can be in fluid communication with the container 170, for instance, by the dispensing assembly 160 having a threaded connection and the container 170 having a complementary threaded connection. Other approaches to connect the dispensing assembly 160 to the container 170 include providing a collar on the stem of the dispensing assembly 160 that connects with container 170. An alternative approach to provide a dispensing assembly 160 that snaps to the container 170 and is sealingly engaged with the container 170. In essence, the dispensing assembly 160 can be connected to the container 170 so that the dispensing assembly 160 and the container 170 are in fluid communication so that treatment composition 20 releasably contained in the container 170 can be transported from the container 170, to the dispensing assembly 160, and out the dispensing outlet 40.

The package 10 can comprise a light 30. The light 30 can serve the purpose of irradiating the treatment composition 20. The treatment composition 20 can be irradiated while the treatment composition 20 is within the package 10 or after the treatment composition 20 has left the package 10. For a treatment composition 20 that comprise a photoactivator, the light 30 can provide the energy that activates the photoactivator.

The package 10 shown in FIG. 1 is a common spray bottle having certain additional features for taking advantage of photoactivated surface treatment compositions. As shown in FIG. 1, the package 10 can comprise a container 170. The container 170 can contain the treatment composition 20. The container 170 can be a plastic bottle. To limit exposure of the photoactivator to ambient light, the container 170 can be opaque. In one embodiment, the container 170 can be an opaque polypropylene or polyethylene terephthalate. Such polymer bottles can be rendered opaque by including carbon black in the bottle constituent material. By opaque, it is meant that visible transmittance is reduced by more than about 80%, or more than about 90%, or more than about 95%, or more than about 99%, as compared to complete radiation transmission. The container 170 can be opaque to electromagnetic radiation in the wavelength region between about 2 nm and about 1200 nm, or even between about 380 nm to about 800 nm. Alternatively, the container 170 can be, by way of non-limiting example, a cardboard carton, as is commonly provided for in milk cartons. Alternatively, the container 170 can be a carton lined with foil, for instance as is provided in milk cartons. Alternatively, the container 170 can be a bag in a box structure such as that commonly used to dispense wine from a box.

A tube 90 can provide for fluid communication between the treatment composition 20 in the container 170 and the dispensing assembly 160. The tube 90 can have a lower end that resides in the treatment composition 20 in the container 170 and an upper end that is connected to the dispensing assembly 160. The treatment composition 20 can be transported through the tube 90 by way of a difference in pressure between the lower end and the upper end of the tube 20. The pressure difference can be provided by a pump applying suction to the upper end of the tube 20. The tube can be ordinary flexible plastic tubing.

The package 10 can comprise an opaque divider 155 that is operatively engaged with the open end 157 of the container 170. For instance the opaque divider 155 can be between the dispensing chamber 60 and the container 170. In one embodiment a connector 150 can provide for connection between the dispensing assembly 160 and the container 170. Such an embodiment can be practical if the main framework of the dispensing assembly 160 comprises a first material and the connector 150 comprises second material. Forming the dispensing assembly 160 of a first material that differs in composition from the container 170 can be practical if a translucent dispensing assembly 160 is used since an opaque connector 150 and/or container 170 may be desired.

A translucent dispensing assembly 160 can be practical if the manufacturer desire that consumers to be able to see the inner parts of the dispensing assembly 160 or if a light 30 is provided within the dispensing assembly 160 and the manufacturer desires that the consumer be able to see the light 30. In such an embodiment, it can be practical to provide for a connector 150 that connects the dispensing assembly 160 to the container 170. The connector 150 can be fabricated from an opaque material so that the connector 150 is opaque. Suitable materials for the connector 150 and the opaque divider 155 include, by way of non-limiting examples, polypropylene, polyethylene, metal, or any other material commonly employed for liquids packaging.

The connector 150 can have a tube opening through which or to which the tube 90 connects to provide for fluid communication between the container 170 and the dispensing assembly 160. The connector 150 can be operatively engaged with the container 170 and dispensing assembly 160 via threaded connections, compression fitting, snap together connections, lug and groove, solvent welded, glue, thermally bonded, or any via any other technique known in the art for connecting to elements.

The dispensing assembly 160 can comprise one or more valves 100. The valves 100 can be ball and socket check valves, bladder check valves, or any other kind of check valve 100 that can provide for one directional fluid transport. The valve 100 immediately downstream from the tube 90 can limit fluid flow in a direction from the dispensing outlet 40 towards the container 170. Such a valve 100 allows for pressure to be developed in the dispensing chamber 60 to drive fluid from the dispensing chamber 60 out the dispensing outlet 40.

The dispensing assembly 160 can be comprised of a plastic material. The dispensing assembly 160 can comprise a pump 138. A pump 138 can comprise a trigger 130, a piston 140, a cylinder 120, a dispensing chamber 60, a spring 110, a valve 100 upstream of the dispensing chamber, and a valve 100 downstream of the dispensing chamber.

The trigger 130 can be sized and dimensioned to conform with one or more fingers of an adult human hand. The trigger 130 can be operatively related to the housing 70 of the dispensing assembly 160 by an axle 132. Optionally, the trigger 130 can be slidingly engaged to the housing 70 of the dispensing assembly 160.

The trigger 130 can be operatively engaged with a piston 140 connected to a cylinder 120. When the trigger 130 is depressed, the piston 140 and cylinder 120 translate into the dispensing chamber 60 to pump the treatment composition 20 out through the dispensing outlet 40. Between the dispensing chamber 60 and the outlet 40 can be a one-way check valve 100 that limits or eliminates flow upstream from the dispensing outlet 40 to the dispensing chamber 60. A one-way check valve 100 that limits flow upstream from the dispensing chamber 60 to the container 170 can also be provided. The spring 110 can be within the dispensing chamber 60. Alternatively, the spring can be external to the dispensing chamber 60 such that the spring is not in contact with the treatment composition 20 during expulsion of the treatment composition. A spring 110 can be operatively related to be between the housing 70 and the trigger 130.

The pump 138 can be a battery driven pump wherein a battery powers a solenoid that moves the piston 140. Optionally the piston 140 can be operatively connected to a dynamo to generate a current that can be stored in a battery that is connected to the light 30 and/or transmitted directly to the light 30.

In one embodiment, a translucent dispensing chamber 60 can be provided to provide fluid communication between the tube 90 and the dispensing outlet 40. By translucent, it is meant that visible light can pass through one or more walls of the dispensing chamber 60 or even be transparent. One or more lights 30 can be provided with the package 10 that can emit light on the dispensing chamber 60 and the contents of the dispensing chamber 60. For instance, one or more lights 30 can be provide within the housing 70 of the dispensing assembly 160. It may be beneficial for the user to pump the trigger 130 multiple times when delivering treatment composition 20 so that fresh treatment composition 20 is expressed from the package 10 since there may be residual activated treatment composition 20 that remains in the dispensing chamber 60 after use.

It can be further beneficial for the pump 138 to be contained within a translucent housing 70. Such an arrangement can allow the user of the package 10 to detect that the light 30 is activating the treatment composition 20 as it is being transported through the dispensing chamber 60. For instance, a switch 80 might be provided on the package 10 for activating the light 30. The trigger 130 might comprise the switch 80. When the user applies force to the trigger 130, the switch 80 might be activated to turn on the one or more lights 30. The user will be able to see the light 30 turn on. The switch 80 can be a switch that can be activated by pressure from the user's fingers as she applies force to the trigger 130. A mechanical switch 80 activated by pressure can be provided proximal a component selected from the group consisting of the axle 132, the trigger 130, the cylinder 120, the spring 110, the dispensing chamber 60, and the piston 140.

In one embodiment, the dispensing assembly 160 has a dispensing outlet 40 and the light 30 is located proximal the dispensing outlet 40. For instance the light 30 can be located proximally above, proximally below, or proximally to the side of the dispensing outlet 40. For an embodiment in which the light 30 is located proximal the dispensing outlet 40, the light 30 can be nearer to the dispensing outlet 40 than the light 30 is to container 170. The light 30 can be above, below, or to the side of the dispensing outlet 40.

The light 30 can be provided at a location from which light emitted from the light 30 can irradiate the treatment composition 20 as it exits the dispensing outlet 40. Such an arrangement can be practical to preserve the viability of the treatment composition 20. For instance, the dispensing assembly 160 may be opaque and the treatment composition 20 will not have access to light until after the treatment composition 20 leaves the package. Without being bound by theory, it is thought that certain photoactivators and product formulations might have chemical compatibility issues between the photoactivated chemistry and the constituent materials of the dispensing assembly 160 or within the formulation itself. Thus, in use, as the user dispenses the treatment composition 20 from the package 10, the treatment composition is conveniently irradiated by the light 30 to activate the photochemistry.

The light 30 can be disposed to emit light in a direction in line with or intersecting the dispensing direction 50 of the package 10. The dispensing direction 50 is taken to be the direction in which the treatment composition 20 exits the dispensing outlet. The treatment composition 20 may exit the dispensing outlet 40 in a stream, spray, or wad of droplets, by way of non-limiting example. If the light is emitted in line with the dispensing direction 50, as the user dispenses the treatment composition 20 onto a surface, she can aim the light at the surface being treated to activate the photoactivator within the treatment composition 20 that is dispensed on the surface. It is contemplated lenses and or mirrors can be provided proximal the light 30 to focus the light 30 upon a particular location.

Optionally, the light can be emitted in a direction intersecting with the dispensing direction 50. In such an arrangement, as the treatment composition 20 exits the dispensing outlet 40, the light 30 can irradiate the treatment composition 20 mid-flight as treatment composition 20 travels from the dispensing outlet 40 to the surface being treated.

The light 30 can be conductively connected to a power source 32. The components for providing light can include a power source 32. The power source 32 can be a battery. The battery can be a conventional AA, C, D, or other standard size battery. The battery can be a nickel-cadmium, lithium ion, or other type of battery. The power source 32 can be conductively connected to the light 30. By conductively connected it is meant that the power can be transferred from the power source 32 to the light 30, for instance by a direct connection in a circuit, induction, or any other technical approach known for transferring energy from a power source 32 to a light 30. The power source 32 can be connected via wires 52 in an electrical circuit that includes the light 30. More complicated circuitry is contemplated, such as an on/off switch 80, a timer, or programmable logic controller that can control the on and off, brightness, spectrum, or other attribute of the light emitted from the light 30. The power source 32 can be replaceable, for example, by way of a replaceable battery that is contained in battery compartment somewhere on the package, for example within the dispensing assembly 160.

The light 30 can be a light emitting diode, incandescent light, an incandescent tungsten filament light bulb, Hg(Ar) UV lamp, fluorescent lamp, compact fluorescent lamp, cold cathode fluorescent lamp, high intensity discharge lamp, or other such light source. The light 30 can emit spectra that is the spectra required to activate the photoactivator in the treatment composition 20. The power source 32 needs to provide sufficient power to power the light 30 to the degree needed. The power source 32 can be a single use power source 32 or can be capable of powering light 30 over multiple uses. The power source 32 can be a replaceable power source 32. For example, the power source 32 can be replaceable battery and the package 10, or component thereof, such as the dispensing assembly 160, can provide a battery compartment that is openable and re-closable that contains the battery.

The light 30 can emit light having a wavelength between about 380 nm and about 800 nm. The light 30 can emit a radiant flux between about 1 mW to about 5 W, alternatively between about 1 mW and about 1 W, alternatively between about 10 mW and about 500 mW. The light 30 can emit a radiant flux in the wavelengths between about 380 nm and about 800 nm between about 1 mW to about 5 W, alternatively between about 1 mW and about 1 mW, alternatively between about 10 mW and about 500 mW.

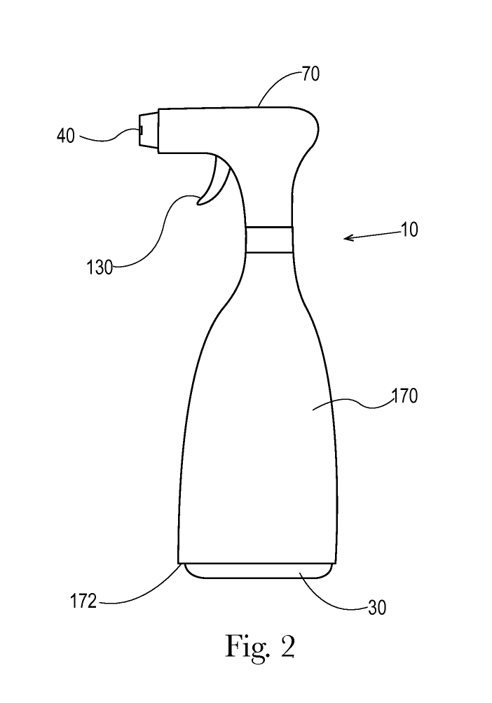

In one embodiment, it can be practical for the light 30 to be operatively connected to the bottom 172 of the container 170, as shown in FIG. 2. In such an arrangement, the user can dispense the treatment composition 20 onto the surface to be treated and then activate the light 30 to shine such light 30 onto the surface being treated and/or cleaned by simply holding the package 10 over such surface. The light 30 can activate the photoactive chemistry in the treatment composition 20. The light 30 can be activated by a user activated switch or can be activated by programmable logic controller that delays activation of the light until after the treatment composition 20 is dispensed from the package 10.

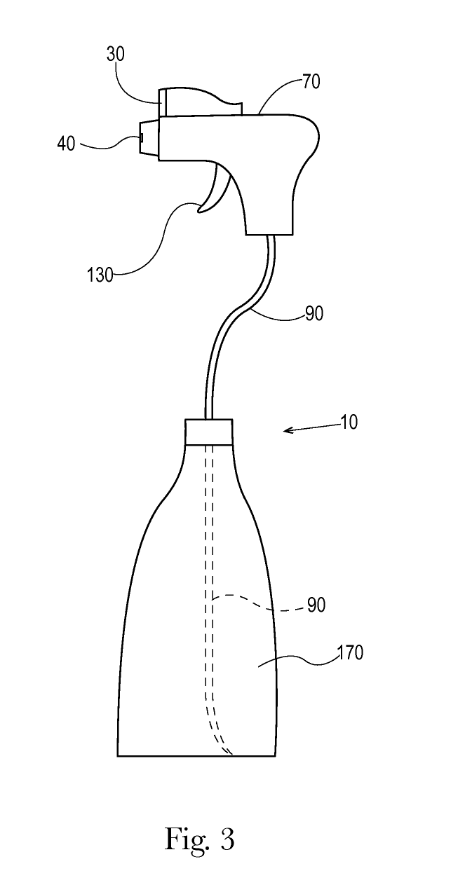

The dispensing assembly 160 can be connected to the container 170 by the tube 90, for example as shown in FIG. 3. In this arrangement, the tube 90 can provide for fluid communication between the container 170 and the dispensing assembly 160. Such an arrangement can provide the user with greater mobility for the dispensing assembly 160 since she does not have to move the container 170 and the treatment composition 20 contained therein around as she dispenses the treatment composition 20 upon different location. For instance, she may hold the container 20 with her left hand and use her right hand to hold and aim the dispensing assembly 160 in the direction she desires. The container 170 can have a handle 174 extending from or forming part of the container 170 that the user can grip to hold the container 170.

Photoactive chemistry can be provided in or with the treatment composition 20 in different forms. For instance, the photoactive chemistry may be provided in a fully formulated liquid or gel.

The light activity of various photochemistry technologies can vary. For instance, some photochemistry technologies may be activated by ultraviolet light and/or visible light. If ultraviolet light activates the photochemistry, then it may be more practical to have the light 30 positioned within the dispensing assembly 160 so that the user is not exposed to the ultraviolet light. For instance, the dispensing assembly 160 can have an opaque housing 70 and the light 30 can be within the housing 70. Is such an embodiment, a portion of or the entire dispensing chamber can be translucent so as to allow the light 30 to shine upon the treatment composition 20 in the dispensing chamber 60.

### Treatment Composition

The treatment composition 20 can be a composition that also provides a cleaning benefit. The treatment composition 20 can include components selected from the group consisting of a surfactant, unencapsulated perfume, perfume microcapsules, bleach, stabilizer, antioxidant, and combinations thereof.

### Photobleach

The treatment composition 20 can comprise a light active bleaching agent. For instance, a suitable light active bleaching agent can be titanium dioxide. Radiation in the visible spectrum of between about 380 nm and about 800 nm can activate the titanium dioxide for the purposes of photo-bleaching. Titanium dioxide can also perform as a photo-bleaching agent when radiated with radiation having wavelength between about 10 nm and about 1200 nm Radiation in the ultraviolet spectrum may be less attractive due to potential human exposure issues.

The treatment composition 20 can comprise titanium dioxide in a quantity ranging from about 0.0000001% to about 25% by weight of the treatment composition 20. The treatment composition 20 can comprise titanium dioxide in a quantity ranging from about 0.005% to about 5% by weight. The treatment composition 20 can comprise other components including, but not limited to, surfactants, perfumes, stabilizers, builders, bleaching agents, disinfectants, enzymes, graying inhibitors, brighteners, and the like.

The titanium dioxide can have a particle size between about 2 nm and about 600 nm, or even between about 100 nm and about 400 nm, or even between about 2 nm and about 80 nm The titanium dioxide can have a specific surface area between about 50 m²/g to about 400 m²/g. The bulk density of the titanium dioxide can be between about 100 g/1 to about 800 g/l. The titanium dioxide can be a carbon modified titanium dioxide having a carbon content of between about 0.01% by weight to about 5% by weight.

The treatment composition 20 can be provided in a liquid, gel, emulsion suspension, aerosol, or other form.

### Photoactivator

The treatment composition 100 can comprise a photoactive component that is a photoactivator. The photoactivator can comprise a photoactive moiety and a hydrophilic moiety. The photoactivator can comprise less than about 35% by weight of the photoactive moiety. The photoactivator can have an absorption band between about 350 nm and about 750 nm, preferably between about 350 nm and about 420 nm.

The photo activator can have the formula:

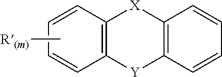

wherein,
X is selected from the group consisting of C, O, NH, C═O, CH₂, CHR″, CR″R′″, S, SO, and SO₂;
Y is selected from the group consisting of C, O, NH, C═O, CH₂, CHR″, CR″R′″, S, SO, and SO₂;
R′, R″ and R′″ may be —H or selected from a group of substituents that include a moiety selected from the group consisting of Oxygen, Nitrogen, Sulfur, Halogen and Hydrocarbon;
at least one of R′, R″ or R′″ further comprises a hydrophilic moiety R;
R is selected from the group consisting of water soluble oligimers, water soluble polymers and water soluble copolymers;
m is an integer from 0-8; and
the combined molecular weight of the substituents R′, R″ and R′″ is greater than 400 atomic mass units (AMU).

The photoactivators of the present invention can comprise a photoactive moiety and a hydrophilic moiety. For purposes of the present invention, the term “hydrophilic moiety” refers to a moiety that is attracted to water and dissolves in water to form a homogenous solution. In one embodiment, the hydrophilic moiety is selected from the group consisting of water soluble oligimers, water soluble polymers and water soluble copolymers. In another embodiment, the hydrophilic moiety may be selected from the group consisting of alkylene oxide oligimers, alkylene oxide polymers, alkylene oxide copolymers, ethylene glycol, vinyl alcohol, vinyl pyrrolidone, acrylic acid, methacrylic acid, acrylamide, cellulose, carboxymethyl cellulose, chitosan, dextran, polysaccharides, 2-ethyl-2-oxazoline, hydroxyethyl methacrylate, vinyl pyridine-N-oxide, diallyl dimethyl ammonium chloride, maleic acid, lysine, isopropyl acrylamide, styrene sulfonic acid, vinyl methyl ether, vinyl phosphoinic acid, ethylene imine, and mixtures thereof. In one embodiment, the hydrophilic moiety may be selected from the group consisting of alkylene oxide oligimer polymers, alkylene oxide oligimer copolymers, vinyl alcohol, vinyl pyrrolidone, acrylic acid, acrylamide, cellulose, and mixtures thereof.

For purposes of the present invention, the term “photoactive moiety” refers to an organic conjugated moiety that is capable of absorbing a photon of light and thereby forming an excited state (singlet or triplet). It will be understood that the term “photoactive moiety does not, however, refer to a charge-transfer excited state. It will further be understood that the photoactive moieties, as disclosed herein, may include a single moiety or a combination of two, three, four or any other number of moieties, as known in the art. The photoactive moiety can be selected from the group consisting of xanthone, xanthene, thioxanthone, thioxanthene, phenothiazine, fluorescein, benzophenone, alloxazine, isoalloxazine, flavin, and mixtures thereof.

Suitable photoactivators are described in detail in U.S. Application Ser. No. 61/930,999, filed Jan. 24, 2014, entitled “PHOTOACTIVATORS” (Attorney Docket No. 13058P).

### Photocatalyzable Composition

The treatment composition can comprise a photocatalyzable composition that comprises a photoactivator, as described previously, and a benefit active precursor. The benefit active precursor can replace, or be used in addition to, the photoactive bleaching agent described above (e.g. titanium dioxide). The treatment composition can be an aqueous solution.

The benefit active precursor can be selected from oxyhalites, such as chlorite salts, chlorate salts, bromite salts, bromate salts, iodite salts, iodate salts, or mixtures thereof. In one embodiment, the benefit active precursor may be a chlorite salt. The benefit active precursor can be sodium chlorite (NaClO₂). In this embodiment, activation of the chlorite salt through transfer of an electron to the photoactivated photocatalyst results in the formation of the benefit active chlorine dioxide (ClO₂). Chlorine dioxide is a potent biocide and bleaching agent. Chlorine dioxide kills microorganisms by disruption of the transport of nutrients across the cell wall. In addition to salts, various other precursor forms are contemplated herein.

The photocatalyzable composition can comprise an electron acceptor. For the purposes of the present invention the term “electron donor” is defined as “a compound or moiety which accepts an electron from the photoactivator when the photoactivator is in a photo-excited state and/or one electron reduced state.” This electron transfer process is normally a very rapid and reversible process.

The ability of the electron acceptor to accept an electron from the excited photoactivator is generally described in Turro, N.J., V. Ramamurthy, and J. C. Scaiano, Principles of Molecular Photochemistry: An Introduction, Chapter 7, p. 41 (University Science Books 2009, Paperback edition). It is understood that the reaction between the reactants is favored when the Gibbs free energy (delta G) is less than 0.

The electron acceptor of the present invention may be any species that accepts an electron from the photoactivator when the photoactivator is in a photo-excited state and/or reduced state. The electron acceptor must be present in the photocatalyzable consumer product composition in sufficient concentration to enable Brownian collisions with the photoactivator, given the concentration of the photoactivator and the lifetime of the photochemically excited state of the photoactivator.

A suitable electron acceptor acceptor can be selected from the group consisting of: viologens, 2,2′ bipyridinium, para-Benzoquinone, 2,3-Dichloro-5,6-dicyano-p-benzoquinone, Tetrahydroxy-1,4-quinone hydrate, 2,5-di-tert-butylhydroquinone, tert-Butylhydroquinone, Anthraquinone, Diaminoanthroquinone, Anthraquinone-2-sulfonic acid, Anthracene, Dicyanobenzene, Chloropentaamine cobalt dichloride, Silver nitrate, Iron Sulfate, Titanium Dioxide, Zinc Oxide, Cadmium Selenide, Thiamine hydrochloride, Thiamine pyrophosphate, Ammonium persulfate, Sodium persulfate, Potassium persulfate, (2,2,6,6-Tetramethylpiperidin-1-yl)oxy, Dimethylthiourea, Tetranitromethane, Lithium acetoacetate, Oxaloacetic acid, Sodium ascorbate, 2,6-Dicholorophenolindophenol, 4-methoxyphenol, 4-Methylmorpholine N-oxide, 4-tert-Butylcatechol, Allopurinol, Pyridoxal 5′-phosphate, pyridoxal hydrochloride, Sodium benzoate, Sodium Nitrate, Sodium Nitrite, Diatomic Oxygen, and mixtures thereof.

Suitable photocatalyzable compositions, including suitable benefit active precursors and suitable electron acceptors, are described in detail in U.S. Application Ser. No. 61/930,993, filed Jan. 24, 2014, entitled “CONSUMER PRODUCT COMPOSITIONS” (Attorney Docket No. 13057P).

The treatment composition 20 can comprise from about 0.0001% to about 5% by weight, alternatively from about 0.0005% to about 3% by weight, alternatively about 0.001% to about 1% by weight photoactivator. The treatment composition 20 can comprise from about 0.01% to about 10%, alternatively about 0.1% to about 8%, alternatively about 0.5% to about 5% by weight benefit active precursor.

### Method of Treatment

Photoactive chemistry can be employed in treating a surface. The surface can be, by way of non-limiting example a countertop, floor, upholstery, appliance, toilet, textile, deck, bathtub, desk top, auto interior, auto exterior, or other surface that needs to be treated.

The method of treating a surface can comprise the steps of; providing a package 10 containing in a container 170 a treatment composition 20 comprising a photoactivator; dispensing the treatment composition 20 onto a surface to be treated; irradiating the treatment composition 20 with a light operatively connected to the package at a juncture in time selected from the group consisting of after the treatment composition 20 has exited said container but before the treatment composition has exited said package, after the treatment composition 20 has exited the package 10 but before the treatment composition 20 has been deposited on said surface, and after the treatment composition 20 has been deposited on the surface.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A package for a treatment composition comprising:
a container;
a dispensing assembly in fluid communication with said container;
a treatment composition comprising a photoactivator, said treatment composition releasably contained in said container; and
a light operatively connected to said container or said dispensing assembly.

2. The package according to claim 1, wherein said dispensing assembly has a dispensing outlet, wherein said light is located proximal said dispensing outlet.

3. The package according to claim 1, wherein said dispensing assembly has a dispensing outlet having a dispensing direction, wherein said light is disposed to emit light in a direction in line with or intersecting said dispensing direction.

4. The package according to claim 1, wherein said container is opaque.

5. The package according to claim 1, wherein said dispensing assembly comprises a pump.

6. The package according to claim 5, wherein said pump comprises:
a tube in fluid communication with said treatment composition;
a dispensing outlet; and
a translucent dispensing chamber providing fluid communication between said tube and said dispensing outlet;
wherein said light is disposed to emit light upon said dispensing chamber.

7. The package according to claim 5, wherein said pump is at least partially within a translucent housing.

8. The package according to claim 5, wherein said pump comprises a trigger operatively related to said pump, wherein said trigger comprises a switch for said light.

9. The package according to claim 6, wherein said container comprises an opaque divider between said dispensing chamber and said container.

10. The package according to claim 1, wherein said container is pressurized to a pressure in excess of atmospheric pressure.

11. The package according to claim 1, wherein said light emits light having a wavelength between about 350 nm and about 750 nm.

12. The package according to claim 1, wherein said light emits a radiant flux between about 1 mW to about 5 W.

13. The package according to claim 1, wherein said photoactivator is selected from the group consisting of xanthone, xanthene, thioxanthone, thioxanthene, phenothiazine, fluorescein, benzophenone, alloxazine, isoalloxazine, flavin, and mixtures thereof.

14. The package according to claim 1, wherein said treatment composition comprises a benefit active precursor.

15. The package according to claim 14, wherein said benefit active precursor is selected from the group consisting of chlorite salts, chlorate salts, bromite salts, bromate salts, iodite salts, iodate salts, and mixtures thereof.

16. A method for treating a surface comprising the steps of: providing a package containing in a container a treatment composition comprising a photoactivator; dispensing said treatment composition onto a surface to be treated; irradiating said treatment composition with a light operatively connected to said package at a juncture in time selected from the group consisting of after said treatment composition has exited said container but before said treatment composition has exited said package, after said treatment composition has exited said package but before said treatment composition has been deposited on said surface, and after said treatment composition has been deposited on said surface.
